(19) United States
(12) Patent Application Publication
(10) Pub. No.: US 2007/0032227 A1
(43) Pub. Date: Feb. 8, 2007

(54) Mobile-phone repairing system

(75) Inventor: Chung-Hsin Chen, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/195,808

(22) Filed: Aug. 3, 2005

(51) Int. Cl. H04M 11/00; H04M 1/66; H04M 3/16; H04M 1/68

(52) U.S. Cl. 455/418; 455/411; 455/410

(57) ABSTRACT

A mobile-phone repairing system includes a server; a lost registration terminal for receiving a report based on a specific identification when a mobile phone is stolen or gets lost such that an IMEI of the lost mobile phone is transmitted to the server for storing thereat; a mobile-phone repairing terminal for reading an individual IEMI of a mobile phone being repaired and transmitting the individual IEMI to the server; and a comparison module disposed in the server for comparing the individual IEMI with respect to the IMEI sent by the lost registration terminal. The comparison module generates an alarm signal in case matching coincidence occurs between the individual IEMI and the IEMI.

### FIELD OF THE INVENTION

The present invention relates to a mobile-phone repairing system, more particularly to a mobile-phone repairing system where the lost mobile phone can be redeemed.

### DESCRIPTION OF THE RELATED ART Guaranty

The communication ability of a mobile phone increases due to advance of the electronic technology. The prevalence of mobile phone is common nowadays and a mobile phone becomes a handy tool for a modern man to communicate with other people.

It is noted that the cost of a mobile phone is not cheap. The user of the mobile phone must spend a relatively large amount of money for purchasing new ones in case the mobile phone is stolen or getting lost.

Nowadays, several manufacturers have organized the maintenance-and-repairing sites into a network to provide after sale services in order to ensure the guaranty of purchasing a mobile phone. The maintenance and repairing of the mobile phones is said to be getting into a standard organization.

Therefore, the main object of the present invention under the presently available circumstances is to provide a network structure having a mobile-phone repairing system where the client or user of the mobile phone can redeem his or her mobile phone in case of getting lost or stolen.

### SUMMARY OF THE INVENTION

The object of the present invention is to provide a mobile-phone repairing system including a mobile-phone repairing terminal for reading the IEMI of a lost mobile phone during the repairing process so that the lost mobile phone can be redeemed thereat.

A mobile-phone repairing system of the present invention includes a server; a lost registration terminal for receiving a report based on a specific identification when a mobile phone is stolen or gets lost such that an IMEI of the lost mobile phone is transmitted to the server for storing thereat; a mobile-phone repairing terminal for reading an individual IEMI of a mobile phone being repaired and transmitting the individual IEMI to the server; and a comparison module disposed in the server for comparing the individual IEMI with respect to the IMEI sent by the lost registration terminal, the comparison module generating an alarm signal in case matching coincidence occurs between the individual IEMI and the IEMI.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic view of a network structure of the present invention;

FIG. 2 is a block diagram illustrating the mobile-phone repairing system of the present invention;

FIG. 3 shows one embodiment illustrating how the mobile-phone repairing system of the present invention reads an IEMI (international mobile equipment identity) of a mobile phone being repaired;

FIG. 4 shows another embodiment illustrating how the mobile-phone repairing system of the present invention reads an IEMI (international mobile equipment identity) of a mobile phone being repaired;

FIG. 5 shows one embodiment illustrating how an alarm signal is transmitted to the server according to the mobile-phone repairing system of the present invention;

FIG. 6 shows another embodiment illustrating how an alarm signal is transmitted to the server according to the mobile-phone repairing system of the present invention; and

FIG. 7 shows still another embodiment illustrating how an alarm signal is transmitted to the user of the lost mobile phone according to the mobile-phone repairing system of the present invention.

DETAILED DESCRIPTION OF THE PREFERRED EMBODIMENTS

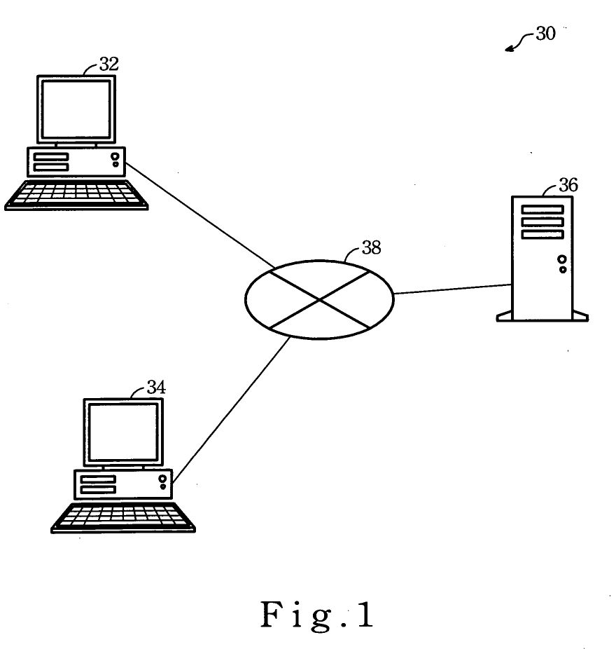

FIG. 1 shows a network structure 30 of the present invention to include a server 36, a lost registration terminal 32, and a mobile-phone repairing system 80 having a mobile-phone repairing terminal 34.

As illustrated, the mobile-phone repairing terminal 34, the lost registration terminal 32 and the server 36 are interconnected to one another via the network 38.

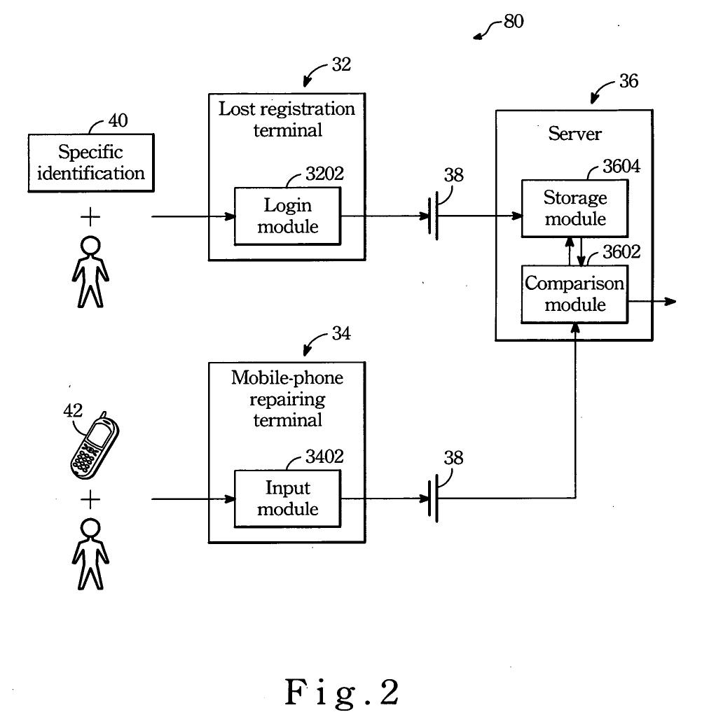

Referring to FIG. 2, the mobile-phone repairing system 80 includes a login module 3202, an input module 3402, and a comparison module 3602.

The login module 3202 is used for inputting a report based on the specific identification 40 when a mobile phone is stolen or gets lost such that an IMEI (international mobile equipment identity) of the lost mobile phone is transmitted to the server 36 for storing within a storage module 3604 of the server 36 by virtue of the network 38.

The input module 3402 is mounted within the mobile-phone repairing terminal 34. The input module 3402 is used for inputting the individual IMEI 4202 of the mobile phone 42 being repaired upon receipt of the mobile phone. Of course, there is an operator at the mobile-phone repairing terminal 34 for inputting the individual IMEI 4202: The individual IMEI 4202 of the mobile phone 42 being repaired is transmitted to the server 36 since the mobile-phone repairing terminal 34 is connected to the server 36 via the network 38.

The comparison module 3602 is disposed in the server 36 for comparing the individual IEMI 422 with respect to the IMEI sent by the lost registration terminal 32. The comparison module 3602 is arranged in such a-manner to produce an alarm signal 50 in case the matching coincidence occurs between the individual IMEI 4202 and the IMEI.

Note that the specific identification 40 can be a bar code printed on a package enclosing the lost mobile phone initially. It can also be a warranty certificate or a voucher issued during purchase of the lost mobile phone.

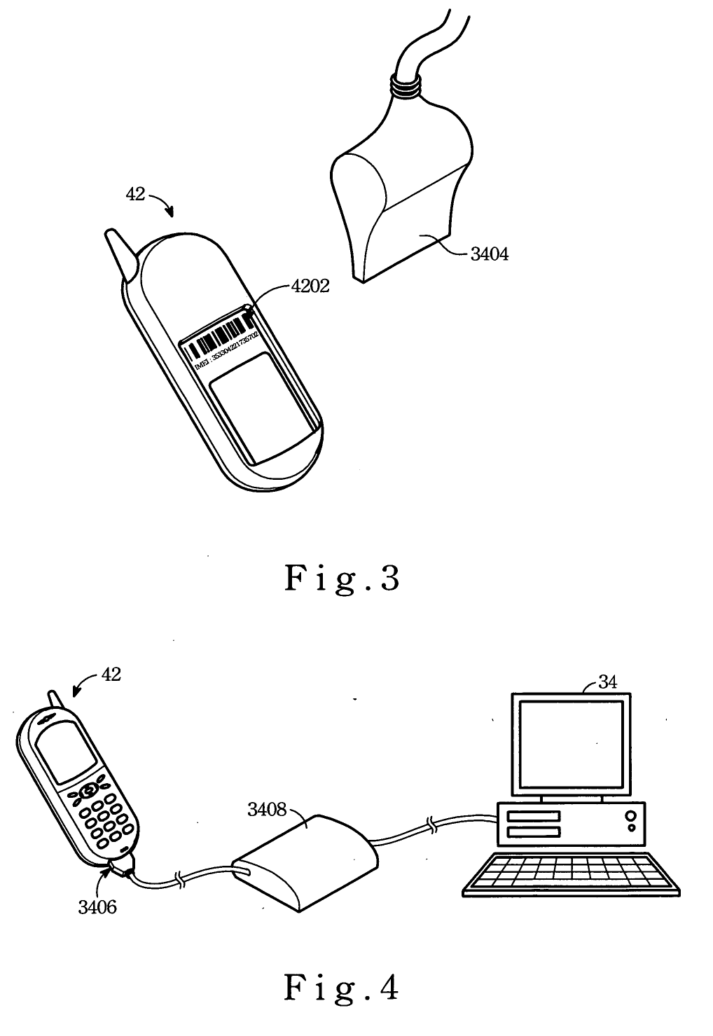

In the aforesaid mobile-phone repairing terminal 34, a scanning device 3404 (see FIG. 3) is used for scanning and reading the individual IMEI 4202. Alternately, a connecting device 3408 (see FIG. 4) is used for interconnecting the phone repairing terminal 34 and the lost mobile phone 42 so that the individual IMEI 4202 is inputted into the terminal 34.

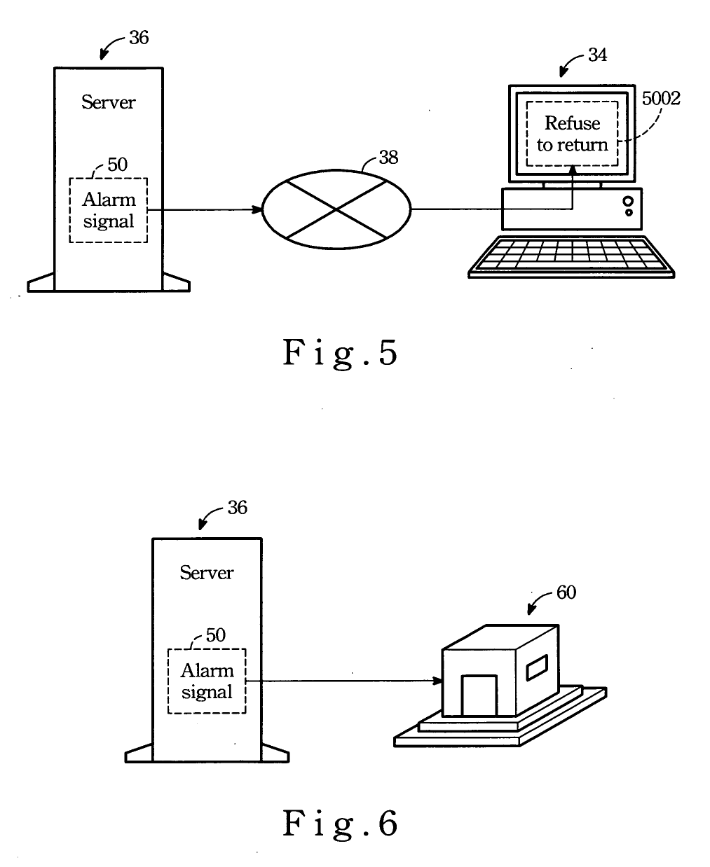

There are several methods to produce the alarm signal 50. As shown in FIG. 5, the alarm signal is a refusal 5002 for not returning the lost mobile phone in case the IMEI is cancelled from the server 36. At the time of report, the user of the lost mobile phone can choose to wait for a few days to recover the lost phone or he can simply ask for a new SIM card so the initial IMEI can be cancelled. Under this condition, the repairer needs not return the repaired phone.

Referring to FIG. 6, in the event that the server 36 is in communicated with a law enforcing unit 60, the alarm signal 50 is transmitted to the law enforcing unit 60 by means of wired communication or wirelessly once the lost mobile phone is listed as stolen.

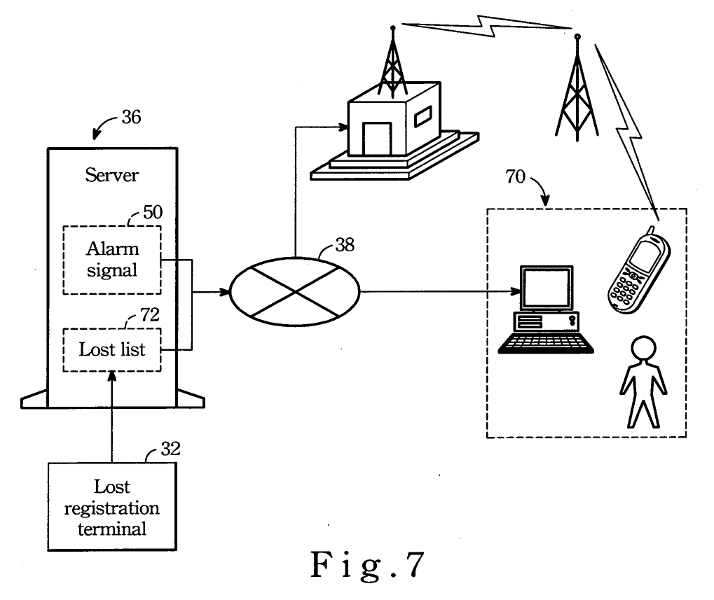

Referring to FIG. 7, the lost registration terminal 32 immediately establishes a list of lost mobile phones upon receiving the report. The lost list is accordingly transmitted to the server 36 for recording thereat. The lost list includes the user name 72 and the contact address or e-mail address. The server 36 is capable of transmitting the alarm signal 50 to the user 72 of the lost mobile phone via e-mail or short message in case the user is still waiting to recover the lost ones (i.e. he or she has not cancelled the IMEI of the lost mobile phone), asking the user to redeem the mobile phone being repaired at the mobile-phone repairing terminal 34.

In summary, the client or user of the lost mobile phone is possible of recovering the lost ones if the lost mobile phone is sent to the mobile-phone repairing terminal 34 for undergoing repairing operation. The mobile-phone repairing terminal 34 is capable of reading and transmitting the individual IMEI 4202 of the mobile phone 42 being repaired to the server 36. Because, the server 36 is stored with the IMEI sent by the lost registration terminal 32, there exists the possibility of recovering the lost mobile phone. The user does not require spending extra expense for buying new ones.

As is understood by a person skilled in the art, the foregoing preferred embodiment of the present invention is an illustration of the present invention rather than limiting thereon. It is intended to cover various modifications and similar arrangements included within the spirit and scope of the appended claims, the scope of which should be accorded the broadest interpretation so as to encompass all such modifications and similar structure.

I claim:

1. A mobile-phone repairing system:
a server;
a lost registration terminal for receiving a report based on a specific identification when a mobile phone is stolen or gets lost such that an IMEI of said lost mobile phone is transmitted to said server for storing thereat;
a mobile-phone repairing terminal for reading an individual IEMI of a mobile phone being repaired and transmitting said individual IEMI to said server; and
a comparison module disposed in said server for comparing said individual IEMI with respect to said IMEI sent by said lost registration terminal, said comparison module generating an alarm signal in case matching coincidence occurs between said individual IEMI and said IEMI.

2. The mobile-phone repairing system according to claim 1, wherein said specific identification is a bar code printed on a package enclosing said lost mobile phone initially.

3. The mobile-phone repairing system according to claim 1, wherein said specific identification is a voucher issued during purchase of said lost mobile phone.

4. The mobile-phone repairing system according to claim 1, wherein said specific identification is a warranty certificate issued during purchase of said lost mobile phone.

5. The mobile-phone repairing system according to claim 1, wherein said mobile-phone repairing terminal includes a scanning device for scanning and reading said individual IEMI of said mobile phone being repaired.

6. The mobile-phone repairing system according to claim 1, further comprising a connecting device interconnecting said mobile-phone repairing terminal and said server for communication therebetween so that said individual IEMI is transmitted to said server via said connecting device.

7. The mobile-phone repairing system according to claim 1, wherein said alarm signal is a refusal for not returning said lost mobile phone.

8. The mobile-phone repairing system according to claim 1, further comprising a law enforcing unit in communication with said server, said database transmitting said alarm signal to said law enforcing unit.

9. The mobile-phone repairing system according to claim 1, wherein said lost registration terminal immediately establishes a list of lost mobile phones upon receiving said report, said lost list including a name of a person using said lost mobile phone prior to being stolen, said server transmitting said alarm signal to said person.
